(19) United States
(12) Patent Application Publication
(10) Pub. No.: US 2025/0054390 A1
(43) Pub. Date: Feb. 13, 2025

(54) FLOOD DETECTION AND ALERT SYSTEM AND METHOD FOR FLEET OF VEHICLES

(71) Applicant: FCA US LLC, Auburn Hills, MI (US)

(72) Inventors: Vinoot Handiganoor, Bangalore (IN); Akhilandeswari Vasagiri, Nandyal (IN); Aravindkumar T, Tiruppur (IN); Habhishek C C S, Chennai (IN)

(21) Appl. No.: 18/446,901

(22) Filed: Aug. 9, 2023

(51) Int. Cl. G08G 1/0967; G01C 21/36; G08G 1/00; H04W 4/021

(52) U.S. Cl. CPC G08G 1/096775; G01C 21/3691; G08G 1/20; H04W 4/021

(57) ABSTRACT

A flood detection and alert system and method for use with a fleet of vehicles. The system and method gather information pertaining to flooding from a fleet of vehicles spread across a geographic area and, with this information, are better able to identify flooded areas and alert vehicles so that such areas can be avoided. By using a cloud-based system to gather and analyze real-time flooding information from a distributed fleet of vehicles, the system and method are able to leverage the benefits of large data for more accurate recognition of flooded areas and more effective remedial measures, such as alerts, notifications and/or alternative routes.

### FIELD

The present disclosure relates to a system and method for use with a fleet of vehicles and, more specifically, to a cloud-based system and method that may be used to detect flooding in certain areas and to alert vehicles that are in those areas or are expected to enter those areas so that the flooding can be avoided.

### BACKGROUND

In geographic regions that experience substantial seasonal precipitation, flooding can be a major problem. In addition to other types of damage and harm, widespread flooding can waterlog and damage large numbers of vehicles that inadvertently become trapped in the flooded areas. If the flooding and water level in a particular area is high enough, water can penetrate various parts of the vehicle and may potentially damage the interior, the engine, electronic devices and/or other vehicle components.

Thus, it would be advantageous to provide a system and method for not only detecting flooding in a certain area, but also for alerting a fleet of potentially affected vehicles so they could avoid the flooding.

### SUMMARY

In at least some implementations, there is provided a flood detection and alert method for detecting flooding and sending alerts to one or more vehicle(s), the method may comprise the steps of: obtaining images with one or more camera(s) and using the obtained images to provide image-based data, the camera(s) are mounted on a host vehicle; obtaining sensor readings with one or more water level sensor(s) and using the obtained sensor readings to provide sensor-based data, the water level sensor(s) are mounted on the host vehicle; obtaining location readings with one or more vehicle position sensor(s) and using the obtained location readings to provide vehicle-based location data, the vehicle position sensor(s) are mounted on the host vehicle; using real-time flooding information to determine if there is a flooding event nearby the host vehicle, the real-time flooding information includes at least one of the image-based data or the sensor-based data; sending the vehicle-based location data from the host vehicle to a backend portion of a cloud-based system when a flooding event nearby the host vehicle is determined; using the vehicle-based location data to identify one or more affected flooding area(s); monitoring locations of a plurality of vehicles with the backend portion of the cloud-based system to determine if any of the vehicles enter or are expected to enter the affected flooding area(s); and sending a real-time flooding notification from the backend portion of the cloud-based system to one or more vehicle(s) when the vehicle(s) enter or are expected to enter the affected flooding area(s).

In at least some implementations, there is provided a flood detection and alert system for detecting flooding and sending alerts to one or more vehicle(s), the system comprises: a plurality of vehicles, at least one of the vehicles is a host vehicle that includes: one or more camera(s) for obtaining images that are used to provide image-based data; one or more water level sensor(s) for obtaining sensor readings that are used to provide sensor-based data; one or more vehicle position sensor(s) for obtaining location readings that are used to provide vehicle-based location data; a vehicle electronic module that includes a data storage unit and an electronic control unit, the vehicle electronic module is configured to use real-time flooding information to determine if there is a flooding event nearby the host vehicle, and the real-time flooding information includes at least one of the image-based data or the sensor-based data; and a communications unit, the communications unit is configured to send the vehicle-based location data when a flooding event nearby the host vehicle is determined; and a backend portion of a cloud-based system, wherein the backend portion is configured to: receive the vehicle-based location data from the host vehicle, use the vehicle-based location data to identify one or more affected flooding area(s), monitor locations of the plurality of vehicles to determine if any of the vehicles enter or are expected to enter the affected flooding area(s), and send a real-time flooding notification to one or more vehicle(s) when the vehicle(s) enter or are expected to enter the affected flooding area(s).

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic block diagram of a flood detection and alert system for a fleet of vehicles;

FIG. 2 is a schematic block diagram of a host vehicle that may be one of the fleet of vehicles from FIG. 1;

FIG. 3 is a flowchart of a flood detection and alert method that may be used with the system from FIG. 1; and

FIG. 4 is a flowchart of a step for identifying affected flooding areas that may be used with the method from FIG. 3.

### DETAILED DESCRIPTION

Referring in more detail to the drawings, there is shown a system and method for detecting flooding in certain areas, for sending alerts to vehicles located in or near the flooded areas, and/or for providing vehicles with alternative routes to avoid the flooded areas. The present system and method gather information pertaining to flooding from a fleet of vehicles spread across a geographic area and, with this information, are better able to identify flooded areas and alert vehicles so that such areas can be avoided. By using a cloud-based system to gather and analyze real-time flooding information from a distributed fleet of vehicles, the present system and method are able to leverage the benefits of large data for more accurate recognition of flooded areas and more effective remedial measures, such as alternative routes.

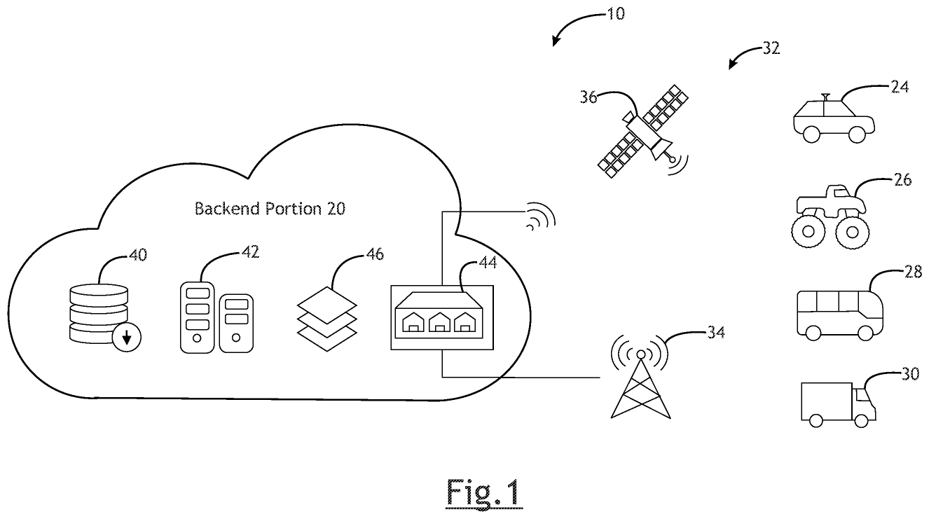

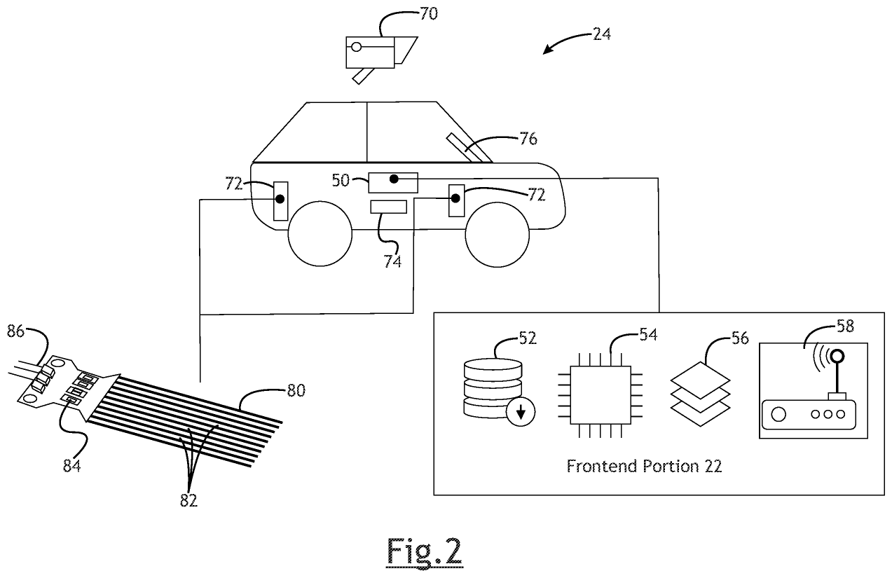

With reference to the schematic block diagrams in FIGS. 1 and 2, there is shown an example of a flood detection and alert system 10 that can detect flooding in certain areas, send alerts to vehicles located in or near the flooded areas, and/or provide vehicles with alternative routes to avoid the flooded areas. System 10 may be a cloud-based system that gathers real-time flooding information from a fleet of vehicles, uses such information to detect and analyze flooding in certain areas, and sends real-time flooding notifications to those vehicles in affected areas. The terms “real-time flooding information” and “real-time flooding notification,” as used herein, do not strictly require that such flooding information and notifications be generated, sent, received and/or otherwise processed at the exact moment when their underlying events or conditions occur in order to be “real-time”; rather, these terms broadly include any such flooding information and notifications that are generally contemporaneous with their underlying events or conditions so that the flooding information and notifications are still relevant or accurate in the context of the present system and method (e.g., within seconds, minutes or even hours of their underlying events or conditions). System 10 may deliver hosted services via the internet and/or other communication networks and may be structured as a public, private or hybrid cloud.

According to one non-limiting example, flood detection and alert system 10 is structured as a private cloud and generally includes a backend portion 20 and a frontend portion 22 that is distributed across a fleet of vehicles, where each vehicle is capable of detecting flooding in its immediately surrounding area, as well as communicating with the backend system 20 over a secure communications network 32 (e.g., secure vehicle-to-cloud (V2C) network). The secure communications network 32 may include a cellular-based network 34, a satellite-based network 36, a city-wide WiFi-based network, some other type of communications network and/or a combination thereof. Although only a few exemplary vehicles 24-30 are shown in the drawings, it should be appreciated that system 10 may interact with a large fleet of vehicles that can include dozens, hundreds, thousands or even more vehicles, and that vehicles 24-30 are only provided for illustration. While system 10 is particularly well suited for passenger and commercial vehicles that are sold and/or used in geographic areas that experience substantial seasonal flooding, it is not so limited. System 10 may be used with any vehicles, including passenger, commercial, industrial, agricultural and/or public transportation vehicles sold in any geographic area.

Backend portion 20 may include any suitable combination of software and/or hardware resources typically found in a backend of a cloud-based system, as best illustrated in FIG. 1, and is generally responsible for receiving and analyzing real-time flooding information from the fleet of vehicles 24-30 and/or other data sources (e.g., weather reporting services, traffic reporting services, etc.) and for sending real-time flooding notifications back to the vehicles in the form of alerts, alternative routes and/or other feedback. The backend portion 20 is typically responsible for managing some of the programs and algorithms that run applications on the frontend portion 22, such as those that inform users within the fleet of vehicles 24-30 of flooded areas and/or provide them with alternative routes. The backend portion 20 may be managed or controlled by the vehicle manufacturer and can be part of a larger cloud-based system that the vehicle manufacturer uses to communicate and interact with a large fleet of vehicles for a multitude of purposes, not just flood detection and alerts. The backend portion 20 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 20). In one example, the backend portion 20 has a number of backend resources including data storage systems 40, servers 42, communication systems 44, programs and algorithms 46, as well as other suitable backend resources. It should be appreciated that backend portion 20 is not limited to any particular architecture, infrastructure or combination of elements, and that any suitable backend arrangement may be employed.

Frontend portion 22 may include any suitable combination of software and/or hardware resources typically found in a frontend of a cloud-based system, as shown in FIG. 2, and is generally responsible for receiving real-time flooding notifications from the backend portion 20 in the form of alerts, alternative routes and/or other feedback, and for conveying such information to the users in the vehicles. Depending on the particular arrangement, the frontend portion 22 may also be responsible for gathering camera, sensor, location and/or other data from devices on the vehicle and sending such information to the backend portion 20 in the form of real-time flooding information, although this depends on the configuration of the overall system 10. The frontend portion 22 is typically responsible for running the applications that interface with the users in the different vehicles 24-30, and for interfacing with the programs and algorithms 46 of the backend portion 20. The frontend portion 22 may also be managed or controlled by the vehicle manufacturer and can be part of a larger cloud-based system that the vehicle manufacturer uses to communicate and interact with a large fleet of vehicles for various purposes, as mentioned above. The frontend portion 22 may be distributed across one or more vehicles 24-30 and may include any suitable combination of software and/or hardware resources including, but not limited to, components, devices, computers, modules and/or systems (each of these resources is referred to herein as a “frontend resource,” which broadly includes any such resource located at the frontend portion 22). In one example, the frontend portion 22 has a number of frontend resources including one or more vehicle electronic module(s) 50 installed in vehicles 24-30, where each vehicle electronic module 50 may include some combination of a data storage unit 52, an electronic control unit 54, applications 56, a communications unit 58 (e.g., one that includes a telematics unit and/or other communication devices), as well as other suitable frontend resources. Vehicle electronic module 50 may be a telematics control module (TCM), a body control module (BCM), an infotainment control module, or any other suitable module known in the art. It is not necessary for the preceding units to be packaged in a single vehicle electronic module, as illustrated in FIG. 2; rather, they could be distributed among multiple vehicle electronic modules, they could be stand-alone units, they could be combined or integrated with other units or devices, or they could be provided according to some other configuration. It should be appreciated that frontend portion 22 is not limited to any particular architecture, infrastructure or combination of elements, and that any suitable frontend arrangement may be employed.

In addition to the frontend portion 22, each vehicle 24-30 may further include one or more camera(s) 70, one or more water level sensor(s) 72, one or more vehicle position sensor(s) 74, one or more user interface(s) 76, as well as other suitable devices. Vehicle devices 70-76 are illustrated as being stand-alone items, however, these devices could be combined or integrated with vehicle electronic module 50 or any other unit, device, computer, module and/or system within the vehicle (each of these resources is referred to herein as a “vehicle resource,” which broadly includes any such resource located at the vehicle). It is worth noting that a vehicle resource may also be a frontend resource and vice-versa. Each vehicle device 70-76 may be connected to the frontend portion 22, the vehicle electronic module 50, the individual units 52-58 of the vehicle electronic module 50 and/or to each other via a vehicle communications network or bus, such as a controller area network (CAN) or a local interconnect network (LIN). The same applies to the different units 52-58 of the vehicle electronic module 50. The following description is directed to a host vehicle 24, however, it should be appreciated that this description equally applies to all the other vehicles of the fleet as well, any of which could be a “host vehicle.”

Camera(s) 70 are mounted on host vehicle 24 and may capture images from a wide or expansive field-of-view around the vehicle, such as needed in order to detect nearby flooding. According to one non-limiting example, camera 70 is a 360° camera that is mounted at an elevated exterior or interior position on the host vehicle 24 (e.g., on the roof, in or near a rearview mirror, on the dashboard, in a front windshield, in a rear window, etc.) such that it can obtain images from multiple sides of the vehicle. It is possible for camera 70 to be based on complementary metal-oxide semiconductor (CMOS) or charge coupled device (CCD) sensor technology, as is oftentimes the case for cameras used with partially or fully autonomous vehicles. Camera 70 is preferably connected to the frontend portion 22 and/or other vehicle devices, such as module 50 and/or units 52-58, so that it can provide those devices with image-based flooding data. In some embodiments, a single camera 70 may be sufficient for surveying the surrounding area and determining if there is any flooding; in other embodiments, multiple cameras 70 may be needed.

Water level sensor(s) 72 are mounted on host vehicle 24 and are arranged to detect vehicle flooding where some portion of the host vehicle is underwater. In one non-limiting example, a separate water level sensor 72 is mounted in or near each vehicle wheel well and provides sensor-based flooding data that indicates if a particular wheel or corner is experiencing flooding and, if so, how much. Each water level sensor 72 may be a high sensitivity water level sensor that includes an elongated body 80 (e.g., about 40 cm-80 cm long), a series of exposed traces 82 formed on the elongated body, one or more resistive component(s) 84, and an electronic connector 86. Some of the exposed traces 82 are connected to ground (grounded traces), some are connected to a small voltage source (e.g., 5v; voltage traces), and some are connected to a sensor (e.g., a voltmeter or the like; sensor traces). It is preferable that the water level sensors 72 be mounted in a generally upright or vertical orientation, as schematically illustrated in FIG. 2. This way, when a sensor becomes partially submerged in water, as can happen during flooding, the sensor and voltage traces can become shorted by the water, thus, causing a voltage drop between the sensor and grounded traces. The amount of the voltage drop between the sensor and grounded traces is dependent on the amount of shorting, which is dependent on how much of the water level sensor 72 is submerged under water, which, in turn, is dependent on the water or flooding level, as is understood by those skilled in the art. According to one example, the water level sensor(s) 72 are mounted on the vehicle so that they measure water levels in a generally vertical range that starts near the bottom of the wheel well and extends towards the top of the wheel well (e.g., water levels from about 15 cm off the ground to about 85 cm off the ground). The water level sensor(s) 72 may be connected to the frontend portion 22 and/or other vehicle devices, such as module 50 and/or units 52-58, so that it can provide those devices with sensor-based flooding data.

Vehicle position sensor(s) 74 are mounted on host vehicle 24 and are configured to obtain a current position or location of the vehicle. According to a preferred example, the vehicle position sensors 74 includes a global positioning system (GPS) unit that uses satellite trilateration to determine vehicle position, as is well known in the art. It is also possible, however, to use inertial navigation system sensors and/or other types of position sensors. In some embodiments, the vehicle position sensor(s) 74 may be part of a telematics unit and/or other device that is provided within the communications unit 58, but this is not necessary. Regardless of the particular type of sensor used, the vehicle position sensor(s) 74 may be connected to the frontend portion 22 and/or other vehicle devices, such as module 50 and/or units 52-58, so that it can provide those devices with vehicle-based and/or area-based location data, as will be explained.

User interface(s) 76 are mounted on host vehicle 24 and, as their name suggests, are designed to interface or interact with users within the vehicle. User interface(s) 76 may include visual interfaces, such as interactive touch screens, infotainment screens, instrument displays, heads-up displays, etc.; they may include audio interfaces like radios, speakers, infotainment systems, audible chimes, etc.; they may include wireless interfaces such as those that connect with a mobile phone or other mobile device; or they may include other types of interfaces. In one non-limiting example, the user interface(s) 76 include both a visual interface in the form of an interactive touch screen, as well as a wireless interface that sends a message to an already paired smart phone or other personal electronic device in the vehicle. The user interface(s) 76 may be connected to the frontend portion 22 and/or other vehicle devices, such as module 50 and/or units 52-58, so that it can receive real-time flooding notifications in the form of alert data and/or alternative route data from the backend portion 20. This data may be received form the backend portion 20 through the frontend portion 22 and/or some other device, or it may be received directly.

It should be appreciated that the camera(s) 70, water level sensor(s) 72, vehicle position sensor(s) 74 and/or user display(s) 76 are not limited to the particular embodiments shown in the drawings and described above and that any suitable alternatives may be used instead.

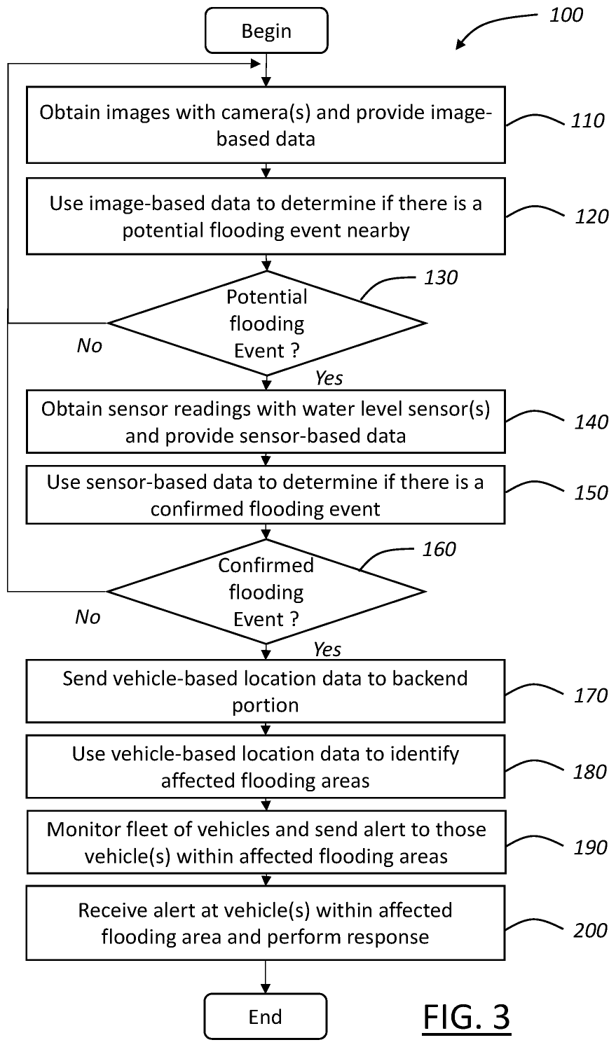

Turning now to FIG. 3, there is shown an example of a method 100 for detecting flooding in certain areas, for sending alerts to vehicles located in or near the flooded areas, and/or for providing vehicles with alternative routes to avoid the flooded areas. The different steps of the flood detection and alert method 100 may be executed or carried out by any suitable combination of components, devices, computers, modules and/or systems residing in the backend portion 20 (backend resources), in the frontend portion 22 (frontend resources), on the various vehicles 24-30 (vehicle resources), at other locations and/or a combination thereof.

Starting with step 110, the method obtains images with camera(s) 70 and uses those images to provide image-based data for further evaluation. The exact manner in which step 110 obtains, pre-processes, and processes the images and/or provides the image-based data can vary depending on the particular implementation. In one non-limiting example, step 110 gathers or obtains raw images (e.g., those with resolution of 1920×1080 pixels) from one or more camera(s) 70, such as a 360° camera mounted on the roof of host vehicle 24, and performs pre-processing tasks on the raw images in order to format them before they are analyzed by more sophisticated and complex image processing functions, like model training and inference functions. The pre-processing tasks may include filtering or removing certain image imperfections, tuning the brightness, correcting the color, resizing the images, changing the orientation, etc. Skilled artisans will appreciate that by performing pre-processing tasks on the images before further image processing takes place, computational resources may be reduced and/or image processing speeds may be enhanced, in addition to other potential benefits. The pre-processing tasks in step 110 may be performed or carried out at the camera(s) 70 (e.g., by a control unit integrated with the camera), by the electronic control unit 54, by the vehicle electronic module 50, by the frontend portion 22, or even by the backend portion 20; however, it is preferable that such tasks be performed at the host vehicle 24. Regardless of whether they are raw images or pre-processed images, the output of step 110 is image-based data that is provided to step 120.

Next, the method uses the image-based data to determine if there is a potential flooding event nearby, step 120. There are many potential image processing and other techniques that may be used to analyze the image-based data from the previous step, including the use of various types of object detection and object recognition programs, algorithms and/or models. One suitable family of object detection techniques uses computer vision tasks and is called regions with convolutional neural networks (R-CNN). R-CNN utilizes deep learning approaches with two stages: a first stage identifies a subset of regions in an image that may include an object, and a second stage classifies the objects in each region. Skilled artisans will appreciate that there are myriad image processing and/or object detection techniques that may be used, such as fast R-CNN and faster R-CNN which are members of the R-CNN family of techniques, as well as others, like the you-only-look-once (YOLO) family of techniques. According to one example, step 120 applies a trained R-CNN technique (with the optional use of an object instance segmentation technique) to the image-based data from the previous step in order to detect or identify a nearby body of water, which can indicate a potential flooding event. Step 120 may use additional image processing and/or computer vision techniques to ensure that a detected body of water is in fact a flooded area, and not merely a naturally occurring body of water, like a lake or river (e.g., step 120 may require that the detected body of water not be on a corresponding navigational map, thereby, suggesting that the body of water is temporary; or step 120 may require that the detected body of water be located in an area not typically associated with a body of water, like a street or parking lot). The image processing tasks in step 120 may be performed or carried out at the camera(s) 70 (e.g., by a control unit integrated with the camera), by the electronic control unit 54, by the vehicle electronic module 50, by the frontend portion 22, or even by the backend portion 20; however, it is preferable that such tasks be performed at the host vehicle 24.

The output of step 120 indicates if the method believes there is a potential flooding event nearby, based on the image-based data. If step 120 concludes that a potential flooding event exists near the host vehicle 24, then the method may initiate a potential flood alert trigger or some other flag and/or software setting, all of which are further examples of image-based data. If step 120 concludes that a potential flooding event does not exist, then the step may reset the potential flood alert trigger and/or otherwise keep that trigger or flag as is. The criteria or parameters used to carry out the determination in step 120 may be configured to be on the cautious side; that is, to error on the side of there being a potential flooding event, as it may be better to mistakenly warn of a non-existent flooding event than it is to fail to warn of an actual flooding event.

Step 130 directs the control or flow of the method based on whether or not a potential flooding event has been determined. As explained above, numerous image processing and/or other techniques may be used to make such a determination and the present method is not limited to any particular one. If step 130, after considering the image-based data provided in the previous step(s), determines that there is no potential flooding event, then the method reverts back to step 110 for further processing. For example, the method could revert back to step 110 and then execute that step periodically (e.g., once per minute, once per hour, once per day, etc.) or it could revert back and execute step 110 based on certain events (e.g., once per ignition start, only when rain sensors detect precipitation, etc.). If, on the other hand, step 130 determines that there is a potential flooding event, then the method may proceed to step 140.

At step 140, the method obtains sensor readings with water level sensor(s) 72 and uses those readings to provide sensor-based data. The precise manner in which step 140 obtains, pre-processes, and processes the sensor readings and/or provides the sensor-based data can vary depending on the particular implementation. According to one non-limiting example, step 140 gathers or obtains sensor readings from four different water level sensors 72, one located at each vehicle wheel or corner. Each sensor reading will indicate if the water level at that particular wheel is below the bottom of the sensor (e.g., no reading or a minimum reading), is between the bottom and the top of the sensor (e.g., a reading indicating a level between the bottom and the top of the wheel well), or is above the top of the sensor (e.g., a maximum reading). The sensor readings indicate if a particular wheel or corner is submerged under water and, if so, how deep the water is. Step 140 may apply pre-processing tasks to the raw sensor readings to convert them into pre-processed sensor readings, such as by filtering or cleaning up noisy or unstable readings with suitable filters like low-pass or Kalman filters, or the step may simply pass along the raw sensor readings as sensor-based data. The pre-processing tasks in step 140 may be performed or carried out at the sensor(s) 72 (e.g., by a control unit integrated with the sensor), by the electronic control unit 54, by the vehicle electronic module 50, by the frontend portion 22, or even by the backend portion 20; however, it is preferable that such tasks be performed at the host vehicle 24. Regardless of whether they are raw senor readings or pre-processed senor readings, the output of step 140 is senor-based data that is then provided to step 150.

The method then uses the sensor-based data from the preceding step to determine if there is a confirmed flooding event, step 150. It should be appreciated that there are many different analysis techniques that may be employed to evaluate the sensor-based data alone or in combination with the image-based data and/or other data in order to confirm a flooding event. According to a non-limiting example, step 150 may evaluate the sensor-based data from all four vehicle wheels and, depending on that evaluation, either confirm or reject the flooding event. For instance, consider the following scenarios: when none of the water level sensors 72 generate sensor-based data indicating that a wheel is waterlogged (i.e., none of the wheels are at least partially submerged under water), then step 150 may conclude that there is no confirmed flooding event; when the sensor-based data from one or more water level sensors 72, but not all of them, shows waterlogging, then step 150 may need to consider other data, such as the image-based data from camera(s) 70, before confirming or rejecting the flooding event; and if all four water level sensors 72 indicate waterlogging, then step 150 may confirm the flooding event. Step 150 can consider the sensor-based data on a binary basis (i.e., where each wheel is deemed to be “flooded” or “not flooded”), or it can consider the respective water levels conveyed by each of the water level sensors 72. To illustrate, if all four water level sensors 72 provide consistent sensor-based data that not only suggests the presence of a flooding event, but also indicates a consistent high or very flooding level, then step 150 will likely conclude that the host vehicle 24 is experiencing an actual flooding event. On the other hand, if three of the four water level sensors 72 send sensor-based data indicating no flooding, but one of the four sensors sends sensor-based indicating low flooding (e.g., a reading suggesting the water level is only up to the bottom of the wheel well), then step 150 may conclude that the vehicle is parked such that one of the wheels is in a water-filled pot hole or the like, but the vehicle is not actually experiencing a flooding event. All of the aforementioned techniques are examples of water level evaluation techniques.

Step 150 may use both sensor- and image-based data, as mentioned above, in order to confirm the flooding event. For example, if the image-based data suggests widespread flooding all around the host vehicle 24 and the sensor-based data from all four water level sensors 72 confirms as much, then step 150 may have a high confidence level in terms of a confirmed flooding event. If, on the other hand, the image-based data suggests flooding on multiple sides of the vehicle, but none of the water level sensors 72 provide sensor-based data indicating a waterlogged wheel, then the method may conclude that the host vehicle 24 is on a bridge or causeway, as opposed to actually being in a flooded area; such a conclusion may require corroboration from navigational map data or the like to confirm the location of the vehicle on the bridge or causeway. Other relevant data, as well as other evaluation or confirmation techniques, could be used by step 150, including whether the host vehicle 24 is stationary or is moving, and whether or not it is raining, to cite just a few possibilities. The data processing tasks in step 150 may be performed or carried out at the water level sensor(s) 72 (e.g., by a control unit integrated with the sensor), by the electronic control unit 54, by the vehicle electronic module 50, by the frontend portion 22, or even by the backend portion 20; however, it is preferable that such tasks be performed at the host vehicle 24.

The output of step 150 indicates if the method believes there is a confirmed flooding event nearby, based on the sensor- and/or image-based data. If step 150 concludes that a confirmed flooding event exists near the host vehicle 24, then the method may initiate a confirmed flood alert trigger or some other flag and/or software setting. If step 150 determines that a confirmed flooding event does not exist, then the step may reset the confirmed flood alert trigger and/or otherwise keep that trigger or flag as is. Steps 120 and 150 are used to corroborate or to confirm one another and to reduce false-positive scenarios, as such, the order in which they are carried out or executed may be switched. For instance, steps 140-160 may be performed first based on sensor-based data, followed by steps 110-130 based on image- and/or sensor-based data, as a particular order or sequence of steps is not necessary. Depending on the embodiment, it is possible for the present method to use: the image-based data to determine if there is a flooding event; the sensor-based data to determine if there is a flooding event; or both the image-based data and the sensor-based data to determine if there is a flooding event. The term “image-based data,” as used herein, broadly includes any images, information, triggers, flags, settings and/or other data that is representative of a flooding event (potential or confirmed) and is at least partially derived from or based on images from camera(s) 70. Non-limiting examples of image-based data include, but are not limited to: raw images, pre-processed images, potential flood alert triggers or flags based on camera images, confirmed flood alert triggers or flags based on camera images, qualitative or quantitative flood level estimates or indicators based on camera images, as well as any other flood-related information or data based on camera images. The term “sensor-based data,” as used herein, broadly includes any sensor readings, information, triggers, flags, settings and/or other data that is representative of a flooding event (potential or confirmed) and is at least partially derived from or based on sensor readings from water level sensor(s) 72. Non-limiting examples of sensor-based data include, but are not limited to: raw senor readings, pre-processed sensor readings, potential flood alert triggers or flags based on sensor readings, confirmed flood alert triggers or flags based on sensor readings, qualitative or quantitative flood level estimates or indicators based on sensor readings, as well as any other flood-related information or data based on sensor readings.

Step 160 directs the flow of the method based on whether or not a confirmed flooding event has been determined. Numerous sensor and image processing and/or other techniques may be used to make such a determination and the present method is not limited to any particular one. If step 160, after considering the sensor-based data, the image-based data, the confirmed flood alert trigger and/or the potential flood alert trigger, determines that there is no confirmed flooding event, then the method reverts back to step 110 for further processing. If, on the other hand, step 160 determines that there is a confirmed flooding event, then the method may proceed to step 170.

Turning now to step 170, the method sends vehicle-based location data to the backend portion 20 of the cloud-based system so that an appropriate alert and/or other remedial action can be developed. As mentioned above, real-time flooding information can include image-based data and/or sensor-based data, but it can also include vehicle-based location data. In order for the present method to be able to effectively alert or warn vehicles located in or near flooded areas, the method must be able to determine where those flooded areas are. Thus, step 170 preferably sends real-time flooding information that includes vehicle-based location data indicating the current location of the host vehicle 24 where flooding has been detected, in addition to optionally sending the image- and/or sensor-based data described above. Step 170 may retrieve GPS and/or other location readings from the vehicle position sensor 74 that indicate the current location of the host vehicle 24 and send that vehicle-based location data to the backend portion 20. Depending the communications protocol and/or other factors, step 170 may: just send the vehicle-based location data; send the vehicle-based location data and the flood alert triggers or other flags; send the vehicle-based location data and the image-based data and/or the sensor-based data; or send the vehicle-based location data, the flood alert triggers or other flags, and the image-based data and/or the sensor-based data; to cited just a few possibilities. If step 170 communicates over a lightweight messaging protocol, as mentioned below, it may be advantageous to just send some of the aforementioned data, as opposed to all of it. The data obtaining tasks in step 170 may be performed or carried out at vehicle position sensor 74 (e.g., by a control unit integrated with the sensor), by the electronic control unit 54, by the vehicle electronic module 50, by the frontend portion 22, or even by the backend portion 20; however, it is preferable that such tasks be performed at the host vehicle 24. Step 170 conveys real-time flooding information that both indicates the presence and/or severity of the flooding, as well as the location of the flooding.

In terms of sending the vehicle-based location data and/or other data to the backend portion 20, this may be accomplished in any number of different ways. In one embodiment, image-based data may be sent from the camera(s) 70 to the communications unit 58 or some other device in the frontend portion 22, sensor-based data may be sent from the water level sensor(s) 72 to the communications unit 58 or some other device in the frontend portion 22, and vehicle-based location data may be sent from the vehicle position sensor(s) 74 to the communications unit 58 or some other device in the frontend portion 22; all of the preceding data transmissions may be sent over the vehicle communications network or bus. Once some or all of the data above has been received at the communications unit 58, that data may be compressed, filtered, packaged, modulated and/or otherwise formatted for wireless transmission from the host vehicle 24 to the backend portion 20. According to one non-limiting example, the vehicle-based location data and optionally the image-based data and/or the sensor-based data can be wirelessly sent from a telematics unit in the communications unit 58 of the frontend portion 22 to the backend portion 20 via a suitable protocol, such as MQ Telemetry Transport (MQTT). MQTT is lightweight open messaging protocol that provides a simple way to wirelessly communicate telemetry information in a bandwidth- and/or resource-limited environment. Skilled artisans will appreciate that actual camera images and sensor readings may not be suitable for transmission over certain lightweight messaging protocols, in which case, just the vehicle-based location data and the flood alert triggers or other flags may be sent. Step 170 may send the real-time flooding information to the backend portion 20 in a single message or in a series of messages and it is not limited to any particular protocol and/or message format.

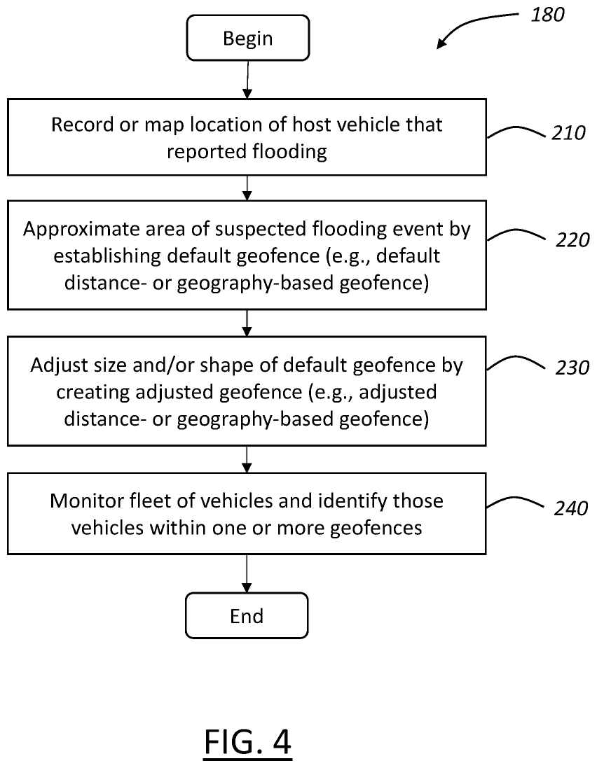

In step 180, which is preferably carried out or executed at the backend portion 20 of the cloud-based system, the method uses the vehicle-based location data and/or any other data that was transmitted to the backend portion to identify affected flooding areas. With reference to FIG. 4, there is shown a more detailed example of a possible implementation of step 180, where the step receives vehicle-based location data and image-based data and/or sensor-based data and uses that data to establish and adjust various types of geofences. Other embodiments, including those that do not use geofences, are certainly possible.

Starting with step 210, the method records or maps the location of the host vehicle 24 that reported the flooding. If host vehicle 24 is the only vehicle that has reported flooding, then the method records or saves the location of the host vehicle 24 and/or other real-time flooding information (e.g., the severity of flooding, the measured water level depth, etc.) and progresses to the next step. If, on the other hand, other vehicles have also reported flooding to the backend portion 20, then the method adds the location of host vehicle 24 to the already saved locations of those other vehicles and saves this data, along with other real-time flooding information, as mentioned above. This information may be stored in data storage system 40 and may be saved as part of a map, as part of a list of locations, as a database entry and/or any other suitable data entry.

Next, step 220 approximates the area of the suspected flooding event and does so according to one of a number of possible techniques, including those that use geofences. The term “geofence,” as used herein, broadly refers to a virtual boundary or perimeter corresponding to a real-world geographic area. In one example, step 220 establishes a default geofence that is centered on the GPS location of the host vehicle 24 (e.g., a circle with a 0.5 km, 1 km or 1.5 km radius and a center corresponding to the host vehicle location). This is an example of a default distance-based geofence, although it should be noted that not all distance-based geofences need to be circular (e.g., they could be oval, square, rectangular and/or any other suitable shape). If the real-time flooding information that was sent to the backend portion 20 suggests that the flooding is connected or related to a particular geographic or topographical feature (e.g., a nearby river, pond or low lying valley) or a particular street or roadway, then step 220 may establish a non-circular geofence that is based on the geographic or topographical feature in question. For example, if the vehicle-based location data and/or the image-based data suggests that the host vehicle 24 is stuck in flooding caused by a nearby river, then step 220 may establish a non-circular default geofence that is based on the shape or course of the river and is centered on the current location of the host vehicle. This is an example of a default geography-based geofence. It should be appreciated that the aforementioned geofencing examples only represent some of the possibilities, as step 220 may employ other techniques, including non-geofencing techniques, to approximate and define the area of the suspected flooding event.

Step 230 may adjust or modify the size and/or shape of the default geofence, thereby creating an adjusted geofence. For instance, if host vehicle 24 provided image- and/or sensor-based data in step 170 indicating that the flooding is severe (e.g., camera images suggesting widespread flooding all around the host vehicle, or sensor readings indicating high water levels at all four wheels), then step 230 may simply increase the radius or size of the default distance-based geofence in order to cover a larger suspected flooding area (e.g., a circle with a 2 km, 3 km or 5 km radius). The converse may apply if the image- and/or sensor-based data suggests minor or insignificant flooding (e.g., a circle with a 20 m, 50 m or 100 m radius). These are examples of adjusted distance-based geofences, since the size of the default geofence has been adjusted based on the severity or scope of flooding. The same concept holds true for geography-based geofences. If image- and/or sensor-based data suggests significant and widespread flooding around the host vehicle 24, then step 230 may increase the size and/or change the shape of the geography-based geofence to better correspond with the scale of flooding. The converse or opposite is possible with insignificant or minor flooding. These are examples of adjusted geography-based geofences.

Another potential category of adjusted geofences includes those whose size and/or shape is adjusted not based on real-time flooding information from a single vehicle, but rather on real-time flooding information from a number of vehicles. To illustrate, if dozens or even hundreds of vehicles in a fleet of vehicles 24-30 simultaneously report flooding in a certain area, then the method may recognize that a large scale flooding event is underway. In such a scenario, step 230 could increase the size of all the distance-based geofences in the affected area (e.g., by increasing the radius 1.5×, 2× or 5×), or it could increase the size of all of the geography-based geofences in the area (e.g., by encompassing an entire river valley, stretch of highway, or even a section of an entire city). In another example, step 230 could merge or combine two or more geofenced areas into a larger combined geofence (e.g., by using pattern detection and evaluation techniques on the real-time flooding information coming in from the fleet of vehicles). Those skilled in the art will appreciate that there are numerous methods and techniques that step 230 could utilize in order to adjust or modify the size, shape and/or location of geofences surrounding vehicle(s) 24-30 and that all such techniques may be employed by the present method. The geofencing tasks in steps 220-230 may be performed or carried out by the frontend portion 22, by the servers 42, by the programs and algorithms 46, or by some other resource in the backend portion 20; however, it is preferable that such tasks be performed at the backend portion 20.

Turning back to FIG. 3, once the affected flooding areas have been identified, step 190 then monitors the fleet of vehicles and sends alerts to those vehicles in the affected areas. According to one possible example, the method uses the cloud-based system to monitor the location of each vehicle that is part of the fleet of vehicles 24-30 and, when one of those vehicle(s) enters an area circumscribed by or otherwise within one or more geofences, step 190 sends a real-time flooding notification to those vehicle(s). The present method is not limited to a specific manner of monitoring vehicles, as numerous techniques may be used. For instance, each vehicle in the fleet of vehicles 24-30 may periodically provide its GPS and/or other location to the backend portion 20, as part of a normal cloud-based, vehicle fleet management system. Step 190 could utilize this location data to determine if any of the vehicle(s) enters a geofence area. Alternatively, the present method could periodically request or otherwise acquire the location of each vehicle in the fleet and, in turn, use that location data to determine if any vehicle enters a geofenced area. In yet another example, step 190 could monitor not just the current location of vehicles, but also the expected or anticipated location of vehicles based on factors, such as, navigational routes, driving patterns, etc. In this way, the present method may be able to identify and warn a vehicle that is likely to travel into an affected flooding area, even if the vehicle is not currently in one.

In terms of alerting or notifying vehicles within the affected flooding areas, step 190 may employ any number of different techniques, including sending a variety of different types of alerts and/or providing alternative routes such that vehicles can avoid the affected flooded areas. In one non-limiting example, step 190 sends an alert to each of the identified vehicles in the form of a real-time flooding notification that warns of flooding in the area, that provides location data of the affected flooding areas (e.g., GPS coordinates corresponding to vehicles reporting flooding, geofenced boundary of the affected flooding area, a larger area encompassing affected flooding areas, etc.), and/or that suggests an alternative route to avoid the affected flooding area. In addition to the information identified above, these alerts may also include the real-time flooding information provided by the affected vehicles (e.g., the actual images of flooding), they may include weather or traffic reports, they could identify roads, tunnels, bridges and/or areas that are historically vulnerable to flooding and that should be avoided, etc.). These alerts could be sent as over-the-air (OTA) alerts or some other type of messages (e.g., ones using a lightweight messaging protocol like MQTT). In terms of alternative routes, it is preferable that step 190 calculate and provide a route that is the shortest or quickest route to the intended destination that avoids the affected flooding areas. Of course, other re-routing strategies and techniques may be used instead.

It may also be desirable for step 190 to manage the time frame in which it monitors and/or sends alerts. For example, if a host vehicle 24 sends vehicle-based location data in step 170 identifying an affected flooding area, then the method may monitor and alerts vehicles entering that area for a certain amount of time (e.g., 30 min, 1 hour, 2 hours, 5 hours, etc.), as determined by a timer or the like. If the method determines that the flooding in that area is severe or if the backend portion 20 receives notifications from other vehicles 26-30 indicating flooding in the same affected flooding area, then the method may increase the time period during which the area is monitored (e.g., 5 hours, 12 hours, 1 day, 2 days, etc.). If any other vehicles enter the geofenced area of the affected flooding area during the set time period, then step 190 may send those vehicles an alert as well. The backend portion 20 can keep track of which vehicles have been notified so as to avoid alerting the same vehicle multiple times within a short period of time (e.g., step 190 may only alert a vehicle once/1 hour, once/2 hours, once/12 hours, etc.). Other limits or parameters could be used by the present method to minimize the usage and/or costs of backend resources, wireless communications, etc. For example, step 190 could be limited to just those vehicles that are part of the fleet of vehicles 24-30, that are paid subscribers of the cloud-based system, or that are members and/or paid subscribers of some other group.

Lastly, the one or more vehicle(s) in the affected flooding areas receive the alert from the backend portion 20 and, in response thereto, may perform any number of different responses to alert their drivers and/or avoid the affected flooding area, step 200. As an example, communications unit 58 may receive the alert or notification from the backend portion 20 and send a corresponding message to the user display 76, which then conveys the alert or warning to the driver via visual, audio, haptic and/or wireless interfaces. The user display 76 can show the affected flooding areas on a map on its screen, as well as an alternative route for avoiding such areas. The user display 76 can uses audio cues to alert the driver of the affected flooding area and then provide audio turn-by-turn directions for avoiding that area. In the case of fully autonomous vehicles, it is even possible for the vehicle electronic module 50 to send instructions to an automated driving module of some type so that the vehicle automatically drives or navigates away from the affected flooding area. Numerous other responses are possible and are envisioned within the context of the present method.

Once the timer for a particular affected flooding area expires, the method may turn off or disable the monitoring and alerting features such that the method simply returns to step 110 and/or ends. Other strategies and techniques for ending the method or looping it back to some starting point may also be employed.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A flood detection and alert method for detecting flooding and sending alerts to one or more vehicle(s), the method comprising the steps of:
obtaining images with one or more camera(s) and using the obtained images to provide image-based data, the camera(s) are mounted on a host vehicle;
obtaining sensor readings with one or more water level sensor(s) and using the obtained sensor readings to provide sensor-based data, the water level sensor(s) are mounted on the host vehicle;
obtaining location readings with one or more vehicle position sensor(s) and using the obtained location readings to provide vehicle-based location data, the vehicle position sensor(s) are mounted on the host vehicle;
using real-time flooding information to determine if there is a flooding event nearby the host vehicle, the real-time flooding information includes at least one of the image-based data or the sensor-based data;
sending the vehicle-based location data from the host vehicle to a backend portion of a cloud-based system when a flooding event nearby the host vehicle is determined;
using the vehicle-based location data to identify one or more affected flooding area(s);
monitoring locations of a plurality of vehicles with the backend portion of the cloud-based system to determine if any of the vehicles enter or are expected to enter the affected flooding area(s); and
sending a real-time flooding notification from the backend portion of the cloud-based system to one or more vehicle(s) when the vehicle(s) enter or are expected to enter the affected flooding area(s).

2. The flood detection and alert method of claim 1, wherein the obtaining images step further comprises obtaining images with a 360° camera that is mounted on a roof of the host vehicle.

3. The flood detection and alert method of claim 1, wherein the obtaining sensor readings step further comprises obtaining sensor readings with four water level sensors, each water level sensor is mounted at or near a different wheel or corner of the host vehicle.

4. The flood detection and alert method of claim 3, wherein each water level sensor is mounted in a different wheel well of the host vehicle and indicates if a water level at that particular wheel well is below a bottom of the sensor, is between the bottom and a top of the sensor, or is above the top of the sensor.

5. The flood detection and alert method of claim 1, wherein the obtaining location readings step further comprises obtaining location readings with a global positioning system (GPS) unit located within the vehicle position sensor.

6. The flood detection and alert method of claim 1, wherein the using real-time flooding information step further comprises using the image-based data and an object detection technique to determine if there is a flooding event nearby the host vehicle.

7. The flood detection and alert method of claim 6, wherein the object detection technique is carried out by vehicle resources mounted on the vehicle and is selected from at least one of the following families of techniques: regions with convolutional neural networks (R-CNN) family of techniques or you-only-look-once (YOLO) family of techniques.

8. The flood detection and alert method of claim 1, wherein the using real-time flooding information step further comprises using the sensor-based data and a water level evaluation technique to determine if there is a flooding event nearby the host vehicle.

9. The flood detection and alert method of claim 1, wherein the using real-time flooding information step further comprises using one of the image-based data or the sensor-based data to determine if there is a potential flooding event nearby the host vehicle, and using the other of the image-based data or the sensor-based data to determine if there is a confirmed flooding event nearby the host vehicle.

10. The flood detection and alert method of claim 9, wherein the using real-time flooding information step further comprises using the image-based data from the camera(s) to determine if there is a potential flooding event nearby the host vehicle, and then using the sensor-based data from the water level sensor(s) to determine if there is a confirmed flooding event nearby the host vehicle, wherein the confirmed flooding event is determined after the potential flooding event.

11. The flood detection and alert method of claim 9, wherein the using real-time flooding information step further comprises using the sensor-based data from the water level sensor(s) to determine if there is a potential flooding event nearby the host vehicle, and then using the image-based data from the camera(s) to determine if there is a confirmed flooding event nearby the host vehicle, wherein the confirmed flooding event is determined after the potential flooding event.

12. The flood detection and alert method of claim 1, wherein the sending vehicle-based location data step further comprises wirelessly sending the vehicle-based location data from a telematics unit on the host vehicle to the backend portion of the cloud-based system via a lightweight messaging protocol, the vehicle-based location data indicates the location of the flooding event.

13. The flood detection and alert method of claim 1, wherein the using vehicle-based location data step further comprises using vehicle-based location data to establish a geofence around the host vehicle.

14. The flood detection and alert method of claim 13, wherein the geofence is either a distance-based geofence that is generally centered on the location of the host vehicle or a geography-based geofence that is generally based on a geographic or topographical feature located near the host vehicle.

15. The flood detection and alert method of claim 13, wherein the geofence is an adjusted geofence that has a size, shape and/or location that is at least partially based on the severity of flooding, and the severity of flooding is at least partially based on the image-based data and/or the sensor-based data.

16. The flood detection and alert method of claim 13, wherein the geofence is a combined geofence that has a size, shape and/or location that is at least partially based on real-time flooding information reported from a plurality of vehicles, the combined geofence encompasses a plurality of individual geofenced areas each associated with one of the plurality of vehicles, where the individual geofenced areas have been combined or merged into a larger geofenced area of the combined geofence.

17. The flood detection and alert method of claim 1, wherein the monitoring step further comprises monitoring the locations of the plurality of vehicles by comparing each vehicle location to a geofenced area corresponding to the affected flooding area(s), by comparing each expected navigational route or driving pattern, when one exists, to the geofenced area corresponding to the affected flooding area(s), or by comparing both.

18. The flood detection and alert method of claim 1, wherein the sending a real-time flooding notification step further comprises sending a real-time flooding notification from the backend portion of the cloud-based system to the vehicle(s) that includes at least one piece of data selected from the list consisting of: a warning of flooding in the affected flooding area, location data of the affected flooding area, an alternative navigation route to avoid the affected flooding area, real-time flooding information previously provided by the host vehicle, or weather or traffic reports.

19. The flood detection and alert method of claim 1, wherein the sending a real-time flooding notification step further comprises sending a real-time flooding notification as an over-the-air (OTA) alert via a lightweight messaging protocol.

20. A flood detection and alert system for detecting flooding and sending alerts to one or more vehicle(s), the system comprises:
a plurality of vehicles, at least one of the vehicles is a host vehicle that includes:
one or more camera(s) for obtaining images that are used to provide image-based data;
one or more water level sensor(s) for obtaining sensor readings that are used to provide sensor-based data;
one or more vehicle position sensor(s) for obtaining location readings that are used to provide vehicle-based location data;
a vehicle electronic module that includes a data storage unit and an electronic control unit, the vehicle electronic module is configured to use real-time flooding information to determine if there is a flooding event nearby the host vehicle, and the real-time flooding information includes at least one of the image-based data or the sensor-based data; and
a communications unit, the communications unit is configured to send the vehicle-based location data when a flooding event nearby the host vehicle is determined; and
a backend portion of a cloud-based system, wherein the backend portion is configured to: receive the vehicle-based location data from the host vehicle, use the vehicle-based location data to identify one or more affected flooding area(s), monitor locations of the plurality of vehicles to determine if any of the vehicles enter or are expected to enter the affected flooding area(s), and send a real-time flooding notification to one or more vehicle(s) when the vehicle(s) enter or are expected to enter the affected flooding area(s).
